(19) United States
(12) Patent Application Publication
(10) Pub. No.: US 2007/0275169 A1
(43) Pub. Date: Nov. 29, 2007

(54) PANEL AND METHOD FOR PRODUCING A PANEL

(75) Inventor: Cevin Marc Pohlmann, Hoisdorf (DE)

Correspondence Address: GREENBLUM & BERNSTEIN, P.L.C., 1950 ROLAND CLARKE PLACE, RESTON, VA, 20191, US

(73) Assignee: FLOORING TECHNOLOGIES LTD., Pieta (MT)

(21) Appl. No.: 11/752,628

(22) Filed: May 23, 2007

(30) Foreign Application Priority Data
May 24, 2006 (DE) 10 2006 024 305.6

(51) Int. Cl. B05D 3/12

(52) U.S. Cl. 427/355

(57) ABSTRACT

A method for producing a panel, in particular a wall panel, ceiling panel or flooring panel of split woodbased-material boards with lateral edges. The boards have a pattern on the top and/or underside. The pattern is coated with a heat-activatable synthetic resin or a radiation-curable varnish. The woodbased-material board, pattern and synthetic resin coat or varnish coat is pressed one under the other by an engraved roller and at least one counterpressure roller. The method includes heating the engraved roller to a temperature of 200-500° C., inserting the panel between the engraved roller and a counterpressure roller, and embossing a structure with a depth of up to 500 μm into the heat-activatable synthetic resin coat on the top of the panel with a pressure of 585-1475 N/cm² (60-150 kg/cm²).

### CROSS-REFERENCE TO RELATED APPLICATIONS

The present application claims priority under 35 U.S.C. §119 of German Patent Application No. 10 2006 024 305.6, filed on May 24, 2006, the disclosure of which is expressly incorporated by reference herein in its entirety.

### BACKGROUND OF THE INVENTION

1. Field of the Invention

The invention relates to a panel and a method for producing a panel having a pattern on the top and/or underside and coated with a heat-activatable synthetic resin or a radiation-curable varnish, and pressed by at least one engraved roller and at least one counterpressure roller.

2. Discussion of Background Information

The production of panels, in particular wall panels, ceiling panels or flooring panels, is known. For production, a coating is applied to a woodbased-material board, e.g., an MDF or HDF board. The coatings are available in a variety of patterns and show, e.g., wood patterns, stone patterns, but also fantasy patterns.

In order for these patterns to be able to imitate a natural material as closely as possible, the coating materials are embossed with a three-dimensional structure corresponding as closely as possible to the natural material. Thus, when the natural material is compared to the imitation on the coating, there should be no difference between the two surfaces as far as possible. This requires the three-dimensional structure of the surface of, e.g., a genuine wood panel, to be imitated as precisely as possible by the synthetic surface of the coating material. As such, the individual pores of the wood and the three-dimensional relief resulting from the earlywood and latewood differences is imitated by an embossing of the coating material. This is known, e.g., as embossing a synchronous pore.

DE 103 56 387 B4 describes a device and a method for smoothing surfaces of workpieces of wood or woodbased materials. To smooth the surface, a heated smoothing tool with a temperature of 200 to 450° C. is guided over the surface of the workpiece of wood or woodbased material.

The production of pattern-synchronous structures is carried out in special presses that hold a corresponding pressing plate for each pattern or for each structure. The pressing plates are called synchronous plates. The grain is then imprinted at the corresponding position of the coating material, e.g., an impregnated paper, by use of the synchronous plates.

Deep and authentic pores require stable presses that render a pressure of at least 390 N/cm² (40 kg/cm²). The smaller the area to be imprinted, the smaller the pressure can be for the embossing. Thus, e.g., a joint in tile structures can be produced with a lower pressure than a so-called hand-scraped pattern (superimposed structure, e.g., a wood structure with worn surface in which the height differences in earlywood and latewood are pressed into the surface of the panel) on a larger area, since the pressure can be provided in a more localized manner. Very high pressures, at least 785 N/cm² (80 kg/cm²), are required for deep hand-scraped patterns.

The presses that make it possible to work with such high pressures are very costly to use and are therefore not often used in industry. Moreover, the degree of utilization of these presses is currently low. If the type of pore needs to be changed, a new and costly pressing plate has to be procured for these presses each time. The problem is that this is a time-consuming and cost-intensive process.

### SUMMARY OF THE INVENTION

Based on the above problem, the invention facilitates the production of panels with a decorated surface and makes it possible to emboss panels without special pressing plates. To solve the problem, the method for producing a generic panel includes heating an engraved roller to a temperature of about 200-500° C., inserting the panel between the engraved roller and a counterpressure roller, and embossing a structure with a depth of up to 500 μm into a heat-activatable synthetic resin coat or varnish coat on the top of the panel with a pressure of about 590-1470 N/cm² (60-150 kg/cm²).

An embossing depth of 80 to 500 μm, and preferably 250 μm, can be achieved by subsequent deep embossing with an engraved roller on split panels before profiling. To this end, the engraved roller and the counterpressure roller are heated to a temperature of about 200-500° C., preferably 230-350° C., and in particular preferably 250° C. The synthetic resin coat or the varnish coat on the top and/or underside of the panels begins to melt due to the high temperature so that a structure, e.g., a three-dimensional image of a wood surface, can be embossed into the panel surface via the engraved roller. For embossing, the panel is inserted between the engraved roller and a counterpressure roller that provides the advance of the panel.

The engraved roller should be at higher temperatures for quicker production speeds. Also, it is advantageously possible through the use of the rollers to apply a high pressing pressure of about 590-1470 N/cm² (60-150 kg/cm²), and preferably 785-1175 N/cm² (80-120 kg/cm²), in order to achieve a deep embossing to a depth of up to 500 μm. If an embossing depth of up to 500 μm is desired, embossing can be carried out with the engraved roller in the melamine coat starting to melt and in the woodbased material underneath. It is possible with the engraved rollers to imitate superimposed structures, so-called hand-scraped patterns, such as, e.g., surfaces of worn wood floors with clear earlywood/latewood differences.

However, it is also possible to emboss pattern-synchronous structures without hand-scraped patterns in panels with the engraved rollers in order to obtain the most exact possible imitation of a natural material. Different structures can be embossed into one panel by arranging several engraved rollers one behind the other.

Chamfers can be embossed by the engraved roller into the lateral edges of the panel. Processing costs can advantageously be saved, since a machining of the panel lateral edges to produce the chamfers is no longer necessary. Since the panel is already coated with a pattern and a synthetic resin before the chamfers are embossed, a surface sealing of the chamfer, e.g., by varnishing, which occurs after a machining, is no longer necessary after the embossing. A subsequent varnishing is critical in particular with structured surfaces, since the three-dimensional structure can be covered up again through the varnish application.

Since the panels can be deformed in a banana-like manner through the high pressure and high temperatures during embossing, it is advantageous to cool the panels with rollers after the embossing. The deformation can be corrected through such process.

With the method according to the invention it is also possible to use the engraved roller to emboss panels already embossed in order to thus produce superimposed structures on the surface of panels. The synthetic resin coat on the top and/or underside of the panels can be applied directly through one or more printing operations. In order to realize particularly thick synthetic resin coats, the synthetic resin can be applied with a weight per unit area of approximately 200 to 300 g/m². In addition to melamine resin other amino resins, e.g., urea resin or phenolic resin or other synthetic resins, can also be applied as synthetic resins.

The varnish coat can be applied directly onto the top and/or underside through one or more printing operations. An electron beam-curable varnish with wear-inhibiting and scratch-inhibiting additives is preferably used in accordance with the invention. Approximately 150 g/m² of the wear-inhibiting and scratch-inhibiting additives can be applied to the panel. The varnish coat is fully hardened with an electron beam with a dose rate of about 60 kGray. After the structuring, a gloss level of greater than or equal to 85 units (measurement according to EN ISO 2813 at an angle of 600) is produced.

The throughput speed can be about 10 to 60 m/min. The throughput speed is preferably 30 m/min. The linear pressure during embossing can be about 196 to 1,470 N/cm² (20 to 150 kg/m²).

In another aspect of the invention, a method for producing a generic panel includes heating the engraved roller to a temperature of about 200-500° C., inserting the panel between the engraved roller and a counterpressure roller, and embossing at least one chamfer on at least one lateral edge (I, II, III, IV) of the panel with a pressure of about 590-1470 N/cm² (60-150 kg/cm²). Through this aspect of the invention, a chamfer can also be embossed on the lateral edges of panels that do not have any deep embossing.

The embossing is carried out under high pressure and leads to a deformation of the pattern coat and synthetic resin coat or varnish coat and the woodbased-material board underneath. Additionally, in accordance with the invention, a subsequent sealing of the chamfer surface is not necessary, since the pattern coat and synthetic resin coat or varnish coat is not worn off. The cost of a subsequent sealing of the chamfer surface does not apply, and the production costs can thus be reduced. The engraved rollers have a corresponding profile for embossing chamfers on the sides.

The electron beam-curable varnish described above can be used as the radiation-curable varnish. Advantageously, the rollers, engraved roller and counterpressure roller are the width of the panel and correspond in circumference to the length of a panel. In this way, it is thus ensured that the embossed pattern is not repeated on a panel. Advantageously, narrow rollers of this type can be produced within a very short time and can be changed easily. Production and investment costs can thus be kept low.

The embossing of panels that have already been embossed and have, e.g., a synchronous pore, is advantageously preserved in a subsequent embossing by the heated engraved roller. In this manner, two embossed images placed one on top of the other can be produced which can complement one another.

The counterpressure roller can also have a pattern or a surface roughness in order to prevent the panel slipping through due to the high pressure. This pattern can be, e.g., a herringbone structure, but a three-dimensional logo, e.g., a company logo, can also be used to increase the roughness, amongst other three dimensional structures. If a roller with a logo is used as a pressure roller, it is also possible to emboss writing or logos onto the top of the panel in a cost-effective and timely manner in order to thus achieve a high recognition value for the manufacturer, e.g., in a marketing campaign.

A plurality of different structures can be embossed into the surface of panels with the method according to the invention. For example, surfaces with a hand-scraped design can be produced or tile joints and tile surfaces, embossed V joints or, using rollers of different sizes with different types of radii, irregular V joints as well as deep synchronous pores and the imitation of signs of wear or age on wood surfaces and finally company logos or writing on the top or underside of the panels.

A generic panel in accordance with the invention includes a structure with at least, in part, a depth of about 500 μm. With this embossing depth particularly deep structures, e.g., hand-scraped patterns, can be produced which also permit a particularly accurate imitation of the imitated material from tactile viewpoints. Advantageously, the pattern can have a wood design, tile design or fantasy design, amongst other designs.

The authentic effect of the designs can be intensified by embossing with particularly deep structures. The pattern or the pattern coat can thus comprise at least one layer that is either embodied as a resin-impregnated paper or applied in a direct printing process. To increase the similarity between a natural pattern and the pattern on the panel surface, the structure can advantageously be embodied in a pattern-synchronous manner.

A particularly high-gloss surface is obtained through the use of an electron beam-curable varnish. The structure can be embossed on the top as well as the underside of the panel.

In another aspect of the invention, the panels have a pattern on at least a top and underside. The panels have a heat-activatable synthetic resin or a radiation-curable varnish. The method comprises heating an engraved roller to a temperature of about 200-500° C.; inserting the panels between the at least one engraved roller and the at least one counterpressure roller; and embossing a structure with a depth of up to about 500 μm into the heat-activatable synthetic resin coat or radiation-curable varnish coat on the top of the panels with a pressure of about 90-1470 N/cm² (60-150 kg/m²). The method includes pattern-synchronous structures embossed in the panels. Several engraved rollers are arranged one behind the other and different structures are embossed into the panels with the several engraved rollers. The chamfers are embossed on at least one lateral edge of the panels with the engraved roller. The panels are cooled after the embossing by the at least one engraved roller and the at least one counterpressure roller. The panels are already embossed and are embossed again by the at least one engraved roller. The method further comprises applying the heat-activated synthetic resin coat through one or more printing operations. The heat-activated synthetic resin coat is applied with a weight per unit area of approximately 200 to 300 g/m². The coating is a melamine resin. The panels are one of a wall panel, ceiling panel or flooring panel of split woodbased-material boards with lateral edges. The temperature is 250° C. The structure has a depth of about 250 μm or a depth of at least 80 μm. The pressure is about 196 to 1,470 N/cm² (20 to 150 kg/m²). The radiation-curable varnish coat is electron beam-curable. The structure is embossed in the top and the underside.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 shows a process sequence to produce an embossing with wood structure on the surface of a panel in accordance with an aspect of the invention; and

FIG. 2 shows a process sequence to produce a fantasy pattern with a joint structure on the top of a panel in accordance with an aspect of the invention.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

The invention relates to a panel and a method for producing a panel. In particular, the panel can be a wall panel, ceiling panel or flooring panel of split woodbased-material boards with lateral edges. The boards have a pattern on the top and/or underside. The pattern is coated with a heat-activatable synthetic resin or a radiation-curable varnish, and a structure of woodbased-material board, the pattern and the synthetic resin coat or varnish coat is pressed one under the other by at least one engraved roller and at least one counterpressure roller.

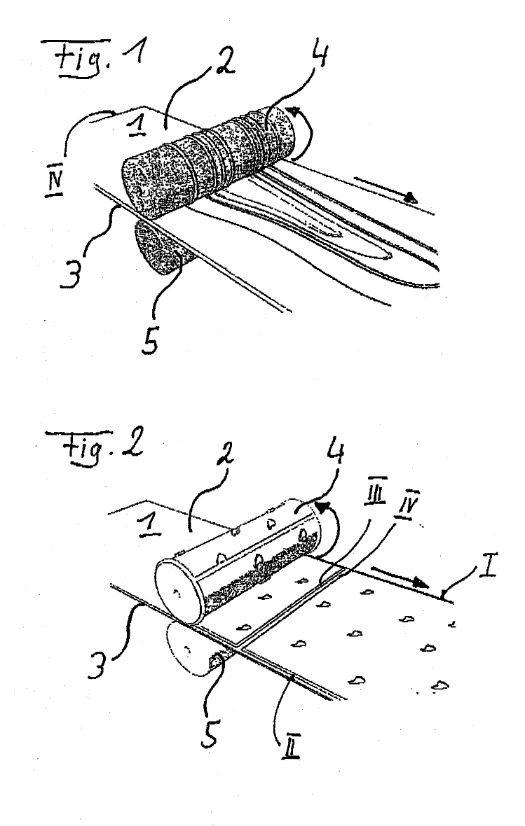

FIG. 1 shows a method for producing a panel 1, in particular a flooring panel in accordance with the invention. The panel 1 includes lateral edges I, II, III, IV, which has a pattern on the top 2 and is coated with a heat-activatable synthetic resin. The pattern and synthetic resin coat are pressed one on top of the other. The panel 1 is inserted between the engraved roller 4 and the counterpressure roller 5. The engraved roller 4 has a temperature of approximately 350° C. A pressure of about 1175 N/cm² (120 kg/cm²) is applied on the top 2 of the panel 1 through the engraved roller 4.

The heat-activatable synthetic resin is activated on the top 2 of the panel 1 by the heated engraved roller 4 and a so-called hand-scraped design is embossed into the top of the panel 1 through the high pressure. The advance of the panel 1 is provided by the counterpressure roller 5 that presses against the underside 3 of the panel 1. The throughput speed can be about 10 to 60 m/min, with a throughput speed preferably of 30 m/min. The counterpressure roller 5 has a herringbone pattern which increases the surface roughness. The counterpressure roller 5 can have other patterns to increase the surface roughness.

The heat-activatable synthetic resin coat can be melamine which starts to melt on the surface through the high embossing temperature and can thus be subsequently deformed. The embossing of the structure takes place in the melamine resin coat as well as in the woodbased material underneath. The structure has a depth of about 250 μm and more preferably the structure has a depth of at least 80 μm.

FIG. 2 shows an alternative method according to the invention. As compared to FIG. 1, the method of FIG. 2 includes a fantasy pattern with tile joints embossed into the top 2 of the panel 1 by an engraved roller 4, as compared to a wood structure in the hand-scraped design of FIG. 1. The method of FIG. 2 does not change when a heat-activatable radiation-curable, in particular electron beam-curable varnish is used instead of a heat-activatable synthetic resin. The panel 1 is provided on the lateral edges I, II, III, IV with tongue/groove profiles corresponding to one another with integrated locking mechanisms for the releasable connection of adjacent panels.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A method for producing panels having a pattern on at least a top and underside, comprising:
coating the pattern with a heat-activatable synthetic resin or a radiation-curable varnish;
pressing a woodbased-material board, the pattern and the heat-activatable synthetic resin coat or radiation-curable varnish coat one under the other by at least one engraved roller and at least one counterpressure roller;
heating the engraved roller to a temperature of about 200-500° C.;
inserting the panels between the at least one engraved roller and the at least one counterpressure roller; and
embossing a structure with a depth of up to about 500 μm into the heat-activatable synthetic resin coat or radiation-curable varnish coat on the top of the panels with a pressure of about 90-1470 N/cm² (60-150 kg/cm²).

2. The method according to claim 1, wherein pattern-synchronous structures are embossed in the panels.

3. The method according to claim 1, wherein several engraved rollers are arranged one behind the other and different structures are embossed into the panels with the several engraved rollers.

4. The method according to claim 1, further comprising embossing chamfers on at least one lateral edge of the panels with the engraved roller.

5. The method according to claim 1, wherein the panels are cooled after the embossing by the at least one engraved roller and the at least one counterpressure roller.

6. The method according to claim 1, wherein the panels are already embossed and are embossed again by the at least one engraved roller.

7. The method according to claim 1, further comprising applying the heat-activated synthetic resin coat through one or more printing operations.

8. The method according to claim 7, wherein in the heat-activated synthetic resin coat is applied with a weight per unit area of approximately 200 to 300 g/m².

9. The method according to claim 7, further comprising coating the panels with a melamine resin.

10. The method according to claim 1, wherein the panels are one of a wall panel, ceiling panel or flooring panel of split woodbased-material boards with lateral edges.

11. An engraved roller for use in the method according to claim 10 comprising a width corresponding to a width of the panels.

12. The engraved roller for use in the method according to claim 11, wherein the engraved roller circumference corresponds to a length of each of the panels.

13. A counterpressure roller for use in the method according to claim 1, wherein the counterpressure roller has a pattern.

14. The counterpressure roller for use in the method according to claim 13, wherein the pattern comprises one of a herringbone pattern or a three-dimensional logo.

15. The method according to claim 1 wherein the temperature is 250° C.

16. The method according to claim 1, wherein the structure has a depth of about 250 μm.

17. The method according to claim 1, wherein the structure has a depth of at least 80 μm.

18. The method according to claim 1, wherein the pressure is about 196 to 1,470 N/cm² (20 to 150 kg/cm²).

19. The method according to claim 1, wherein a throughput speed of the panels is about 10 to 60 m/min.

20. The method according to claim 19, wherein the throughput speed is about 30 m/min.

21. The method according to claim 1, wherein the radiation-curable varnish coat is electron beam-curable.

22. The method according to claim 1, wherein the structure is embossed in the top and the underside.

23. A method for producing a panel having a pattern on at least one of a top and underside, the pattern being coated with a heat-activatable synthetic resin or a radiation-curable varnish, and a woodbased-material board, the pattern and the heat-activatable synthetic resin coat or radiation-curable varnish coat being pressed one under the other by at least one engraved roller and at least one counterpressure roller, comprising:
heating the engraved roller to a temperature of about 200-500° C.;
inserting the panel between an engraved roller and the counterpressure roller; and
embossing at least one chamfer on at least one lateral edge of the panel with a pressure of about 590-1470 N/cm² (60-150 kg/cm²).

24. An engraved roller for use in the method according to claim 23, comprising a width corresponding to a width of the panel.

25. The engraved roller for use in the method according to claim 24, wherein the engraved roller has a circumference corresponding to a length of the panel.

26. A counterpressure roller for use in the method according to claim 23, wherein the counterpressure roller has a pattern.

27. The counterpressure roller for use in the method according to claim 26, wherein the pattern comprises one of a herringbone pattern and a three-dimensional logo.

28. The method according to claim 23, wherein the temperature is 250° C.

29. The method according to claim 23, wherein the structure has a depth of 250 μm.

30. The method according to claim 23, wherein the structure has a depth of at least 80 μm.

31. The method according to claim 23, wherein the pressure is about 196 to 1,470 N/cm² (20 to 150 kg/cm²).

32. The method according to claim 23, wherein a throughput speed of the panel is about 10 to 60 m/min.

33. The method according to claim 32, wherein the throughput speed is about 30 m/min.

34. The method according to claim 23, wherein the radiation-curable varnish coat is electron beam-curable.

35. The method according to claim 23, wherein the structure is embossed in the top and the underside.

36. A panel of split woodbased-material boards with lateral edges having a pattern coated with a heat-activatable synthetic resin or a radiation-curable varnish, and a structure of woodbased-material board, pattern and synthetic resin coat or varnish coat being pressed one under the other, at least a top has a pattern, and a structure at least in part of a depth, of about 500 μm.

37. The panel according to claim 36, wherein the pattern has a wood design, tile design or fantasy design.

38. The panel according to claim 36, wherein the pattern comprises at least one layer that either comprises a resin-impregnated paper or can be applied in a direct printing process.

39. The panel according to claim 36, wherein the structure is embodied in a pattern-synchronous manner.

40. The panel according to claim 36, wherein at least the surface of the top is high-gloss.

41. A method for producing at least one panel having a pattern on at least a top and underside, the at least one panel having a heat-activatable synthetic resin or a radiation-curable varnish, the method comprising:
heating an engraved roller to a temperature of about 200-500° C.;
inserting the panels between the at least one engraved roller and the at least one counterpressure roller; and
embossing a structure with a depth of up to about 500 μm into the heat-activatable synthetic resin coat or radiation-curable varnish coat on the top of the panels with a pressure of about 90-1470 N/cm² (60-150 kg/cm²).
